(19) United States
(12) Patent Application Publication
(10) Pub. No.: US 2019/0210031 A1
(43) Pub. Date: Jul. 11, 2019

(54) LABORATORY EQUIPMENT HOLDER

(71) Applicant: LEIBNIZ-INSTITUT FUER POLYMERFORSCHUNG DRESDEN E.V., Dresden (DE)

(72) Inventors: Marcus HEINZE, Dresden (DE); Felix MUELLER, Ossling (DE); Yves BORN, Dresden (DE); Sebastian STEIN, Dresden (DE)

(73) Assignee: LEIBNIZ-INSTITUT FUER POLYMERFORSCHUNG DRESDEN E.V., Dresden (DE)

(21) Appl. No.: 16/094,314

(22) PCT Filed: Apr. 12, 2017
(86) PCT No.: PCT/EP2017/058764

§ 371 Date: Mar. 22, 2019

(30) Foreign Application Priority Data
Apr. 18, 2016 (DE) 10 2016 206 457.9

(51) Int. Cl. B01L 9/00; B01L 3/08

(52) U.S. Cl. CPC B01L 9/00; B01L 3/08; B01L 9/50

(57) ABSTRACT

Laboratory equipment holder to mount and position glass flasks in a simple and secure manner. The laboratory equipment holder includes of a component on which at least one holding device is attached and both the component and also the holding device and the connection between the component and holding device can be mechanically loaded with at least one filled piece of laboratory equipment, and the component includes on one of its sides at least one recess. At least the end thereof within the component is embodied in an at least semicircular manner and at least the smallest diameter of the semicircular section of the recess is smaller than the largest diameter of the truncated conical neck of the piece of laboratory equipment and/or is smaller than the largest diameter of the beaded edge-like enlargement of the neck of the piece of laboratory equipment.

The invention concerns the fields of equipment engineering and chemistry and relates to a laboratory equipment holder, such as that which can be used to mount glass flasks in particular, such as Erlenmeyer flasks or round-bottom flasks, for example in fume hoods or in chemical storage.

Round-bottom flasks are an indispensable part of the technical equipment in the chemical industry, in laboratory operations, and in chemical research.

Round-bottom flasks are composed of a lower, spherical section and a cylindrical neck. They are reaction vessels that are made of glass and standardized in accordance with DIN EN ISO 24450 2006-02. They are produced in various different sizes (from 10 mL up to 25 L) and are also manufactured as multi-neck flasks with straight or side necks. Round-bottom flasks with a standard ground glass joint have many different socket sizes in the laboratory. The most common size, NS 29/32, is used to connect other pieces of glassware (for example, condensers). In addition to this, round-bottom flasks with a spherical ground glass joint are used in laboratories and engineering, for example, as a collecting vessel for the distillate on rotary evaporators. Round-bottom flasks can—in contrast to flat-bottom flasks (for example, Erlenmeyer flasks)—be placed under a vacuum without there being a potential risk of an implosion. The round shape also enables an even heating (Wikipedia, German-language keyword “Rundkolben”).

The standard ground glass joint represents the most common connection of two pieces of glassware in chemistry. A distinction is made between sockets and cones on the equipment, wherein a cone always fits into a corresponding socket. The socket is located, for example, on the round-bottom flask; the cone is located on the relevant additional pieces of assembly equipment, such as glass stoppers. The standard ground glass joints in a conical shape (DIN 12 242) are, for example, available in the sizes NS 5/13, 7/16, 10/19, 12/21. The first number thereby indicates the upper diameter in millimeters; the second indicates the respective length.

The slope of the standard ground glass joint is always 1:20, which corresponds to a taper of 1:10 (Wikipedi a, German-language keyword “Normschliff”).

For the use of round-bottom flasks of this type, various pieces of auxiliary equipment are required in order to be able to achieve safe and trouble-free use. Thus, joint clips are known, for example, which are used to prevent the loosening of the stoppers in the conical ground glass joints in the case of slight pressure surges or slight tensile loading.

Different types of greases are also used so that the conical ground glass joints do not stick together during use.

Glassware, racks or rings are known for the positioning of round-bottom flasks.

From JP 2008221189 A1, a flask holder is known which is composed of a mounting component with round openings for the base of round-bottom flasks and of a holder component that is arranged above the mounting component by means of two supports and has rectangular openings for the necks of the round-bottom flasks.

Round-bottom flask carrier racks, WINLAB®, are also known, for example, with which racks round-bottom flasks can be safely stored and transported. The round-bottom flasks stand in an absolutely secure position and can be transported without any risk. Up to 12 round-bottom flasks can be stored in one rack. In addition, the rack can also be used as an ice bath. The carrier parts are available for two round-bottom flask sizes (Reiss-Laborbedarf. de).

A disadvantage of this solution is that the carrier racks are not stackable.

Also widely used to position round-bottom flasks are cork rings in different sizes (Reiss-Laborbedarf.de).

In addition to these pieces of laboratory equipment, beakers are also always a secure storage option for round-bottom flasks.

The disadvantage of the solutions for positioning round-bottom flasks on cork rings is mainly that they can tip over.

For positioning in beakers, it is disadvantageous that a second glass vessel is also always necessary, and also that only one round-bottom flask each can be placed in a beaker. Overall, the disadvantage of all solutions is that they have a large footprint.

The object of the present invention is to specify a laboratory equipment holder that mounts and positions glass flasks in particular, such as Erlenmeyer flasks or round-bottom flasks, of an equal or different size, together and at the same time in a simple and secure manner.

The object is attained by the invention disclosed in the claims. Advantageous embodiments are the subject matter of the dependent claims.

The laboratory equipment holder according to the invention is composed of a component and at least one piece of laboratory equipment having at least one neck, which piece of laboratory equipment is arranged such that it is suspended on the laboratory equipment holder, wherein the outer shape of the neck is in the form of a truncated cone with the larger diameter of the truncated cone towards the end of the neck, and/or a beaded edge-like enlargement around the neck is present towards the end of the neck, and wherein at least one holding device is attached to the component, and both the component and also the holding device and the connection between the component and holding device can be mechanically loaded with at least one filled piece of laboratory equipment, and the component comprises on one of its sides at least one recess, and the laboratory equipment is introduced solely from the opening side of the recess, and. wherein at least the end of the recess within the component is embodied in a semicircular manner, and at least the smallest diameter of the semicircular section of the recess is smaller than the largest diameter of the truncated conical neck of the at least one piece of laboratory equipment and/or is smaller than the largest diameter of the beaded edge-like enlargement of the neck of the at least one piece of laboratory equipment.

Advantageously, the component has a rectangular, round, oval, square, or triangular shape.

Likewise advantageously, the thickness of the component is smaller, in particular significantly smaller, advantageously more than 5 times smaller, than the other dimensions of the component.

Also advantageously, the longer sides of the component are significantly longer, advantageously more than 5 times longer, than the short sides, and the thickness of the component is significantly smaller, advantageously more than 5 times smaller, than the length of the short sides.

And also advantageously, two holding devices are present on opposite sides of the component.

It is also advantageous if one or more pieces of glass laboratory equipment, in particular glass flasks such as Erlenmeyer flasks or round-bottom flasks, are positioned in one recess each such that they are simultaneously suspended next to and/or above one another and/or in different sizes and shapes.

Furthermore, it is advantageous if the component is composed of metal, such as stainless steel or aluminum, or of plastic or of composite materials, wherein the materials of the component are advantageously resistant to chemicals.

It is likewise advantageous if the holding device is present in the form of a rod-shaped holding device, wherein the holdin device is connected to the component in a non-positive fit and/or material bond.

And it is also advantageous if at least one, advantageously multiple, such as two to five, recesses are present in the component, wherein the recesses are advantageously arranged at an equal distance to one another and with the same dimensions.

It is also advantageous if at least two recesses with different dimensions are present in the component and, in the case of more than two recesses, if the recesses are present at different distances to one another.

It is furthermore advantageous if one, multiple, or all recesses comprise in a vertical direction a chamfer and/or comprise rounded edges and corners at the openings of the recesses.

And it is also advantageous if the distance between the non-semicircular, parallel sides of the recesses has dimensions that are between 1% and 10% smaller than the largest diameter of the truncated conical neck of the at least one piece of laboratory equipment and/or than the largest diameter of the beaded edge-like enlargement of the neck of the at least one piece of laboratory equipment.

It is also advantageous if the at least semicircular section of the recess constitutes a circular arch segment between ≥180′ and <360°, preferably between 190° and 310°, formed by the component material.

It is likewise advantageous if the recesses are provided with inserts.

With the invention, it becomes possible for the first time to specify a laboratory equipment holder that mounts and positions in particular glass flasks, such as Erlenmeyer flasks or round-bottom flasks, of an identical or different size, together and at the same time in a simple and secure manner.

This is achieved by a laboratory equipment holder that is essentially composed of a component which comprises on a side of the component at least one holding device. The holding device is thereby advantageously embodied to be rod-shaped.

According to the invention, it must be ensured that both the component and also the holding device and the connection between the component and holding device are embodied to be mechanically loadable to such an extent that the component, the holding device, and the connection between the component and holding device support without any problem at least one filled piece of glass laboratory equipment or, depending on the number of recesses, a corresponding number of filled pieces of glass laboratory equipment.

The holding devices are connected to the component at least in a non-positive fit and/or material bond, for example, are welded, soldered or glued, wherein it is also particularly advantageous if this connection is resistant to chemicals.

The holding devices are thereby detachably connected to a support or stand via clamp connections or hole connections, whereby the component can be positioned at different heights above the base. Several of the components according to the invention can also be attached above one another on the supports or stands.

The distances between the components according to the invention positioned above one another are based on the size of the respective laboratory equipment that is to be held.

Within the scope of this invention, laboratory equipment is to be understood as laboratory equipment for the laboratory equipment holder according to the invention, which is all laboratory equipment that comprises at least one neck, wherein the outer shape of the neck is in the form of a truncated cone with the larger diameter of the truncated cone towards the end of the neck, and/or a beaded edge-like enlargement around the neck is present towards the end of the neck.

The component can have a rectangular, round, oval, square, or triangular shape, wherein advantageously the thickness of the component is smaller, in particular significantly smaller, advantageously more than 5 times smaller, than the other dimensions of the component. The dimensions of the component are, according to the invention, thereby such that the longer sides of the component are significantly longer, advantageously more than 5 times longer, than the short sides, and the thickness of the component is also significantly smaller, advantageously more than 5 times smaller, than the length of the short sides.

This applies in particular to the advantageous rectangular shape of the component with a small thickness.

Furthermore, it is advantageous if the laboratory equipment holder according to the invention comprises two holding devices on opposite sides of the component, since a secure arrangement of the component on two opposing stands or supports is thus possible without any problem.

The component according to the invention with at least one holding device comprises on one side at least one recess. Advantageously, at least two to five recesses are present which can have identical and/or different dimensions and identical and/or different distances to one another.

The dimensions of the recesses in the component are based on the outer dimensions of the neck of the laboratory equipment, wherein at least the smallest diameter of the semicircular section of the recess is smaller than the largest diameter of the truncated conical neck of the at least one piece of laboratory equipment and/or is smaller than the largest diameter of the beaded edge-like enlargement of the neck of the at least one piece of laboratory equipment. The dimensions of the distances between the recesses in the component are based on the maximum dimensions of the width of the laboratory equipment, wherein in the case of round-bottom flasks, for example, recesses in the component can also remain free as a result of the maximum thickness of round-bottom flasks, in order to ensure a secure suspended mounting of the round-bottom flasks (see also FIG. 2).

The recess is, at least at the end within the component, embodied in a semicircular manner, wherein at least the smallest diameter of the semicircular section of the recess is smaller than the largest diameter of the truncated conical neck of the at least one piece of laboratory equipment and/or is smaller than the largest diameter of the beaded edge-like enlargement of the neck of the at least one piece of laboratory equipment.

Since, according to the invention, the smallest diameter of the semicircular section of the recess is smaller than the largest diameter of the truncated conical neck of the laboratory equipment, secure support in the recess is provided on the one hand and, on the other hand, the introduction of the laboratory equipment solely from the front, from the opening side of the recess, can be facilitated in that the introduction into the recess takes place at a region of the neck with the diameter of the truncated conical neck that is located farther away from the opening, and is therefore smaller, in particular significantly smaller, than the smallest diameter of the semicircular section of the recess. Once the neck is located in the recess, the laboratory equipment can then be lowered within the recess and is securely mounted or held. A slipping or tipping out of the recess is not possible.

If a beaded edge-like enlargement around the neck is present towards the opening, which enlargement is usually arranged directly around the opening, the smallest diameter of the semicircular section of the recess must also be smaller than the largest diameter of the beaded edge-like enlargement so that the laboratory equipment is securely mounted in the recess. In this case, the introduction of the laboratory equipment also takes place solely from the front, from the opening side of the recess, and occurs at a region of the neck below the beaded edge-like enlargement. The laboratory equipment is then lowered onto the recess, after which it rests securely at least on the beaded edge-like enlargement of the neck.

If parallel sides of the recesses are present towards the semicircular section of the recess, the distance between the parallel sides of the recess should maximally correspond to the smallest diameter of the recess and, at the same time, should minimally have a distance which is in every case greater than the smallest diameter of the tapered conical neck and/or below the opening and the beaded edge-like enlargement of the neck.

As a result of these dimensions of the recess, and if the parallel sides of the recess are present, the laboratory equipment can be slid into the recesses without jamming or tilting.

The outer dimensions of the neck on glass flasks are usually embodied conically, that is, in the shape of a truncated cone, in line with the conical ground glass joints in the interior of the neck of the glass flasks. Because the ground glass joints in the interior of the neck on glass flasks are, with regard to their dimensions, embodied mainly in accordance with DIN, it is thus also possible, using the typical glass thickness of the necks on glass flasks, to make a relatively reliable statement about the outer dimensions of the truncated conical neck of the laboratory equipment which is to be held according to the invention, so that the size of the dimension of the recesses can also be determined in a region that easily permits the matching of glass flasks that differ in size with respect to their neck. In this manner, a simple and secure positioning of differently sized laboratory equipment / glass flasks can also be achieved in the case of multiple holding devices.

Furthermore, it is advantageous if the at least semicircular section of the recess constitutes a circular arch segment between ≥180° and <360°, preferably between 190° and 310°, formed by the component material.

This means that the at least semicircular section of the recess much more clearly approximates a circular shape, wherein the opening of the recess is also founed by parallel sides which are, however, arranged at a smaller distance to one another than the diameter of the incomplete circle of the recess. Furthermore, the opening of the recess must, of course, have at least dimensions such that the necks of the laboratory equipment to be held fit, at least at their smallest diameter, into the opening.

To reduce the dimensions of recesses present in a component according to the invention, it is also possible according to the invention to fit an insert, for example, made of plastic, into the recess, which insert enables laboratory equipment with smaller outer diameters of the truncated conical neck to be securely mounted and held.

The maximum thickness of the component is, according to the invention, smaller than the height of the truncated conical neck of the laboratory equipment that is to be mounted and held.

Particularly advantageously, the laboratory equipment holder according to the invention can be used for round-bottom flasks. All pieces of laboratory equipment can be positioned next to and/or above one another at the same time with the laboratory equipment holder according to the invention. Likewise, a secure positioning of differently sized and differently shaped laboratory equipment at the respective recesses is possible.

The component is advantageously composed of metal, such as stainless steel or aluminum, or of plastic or of composite materials. It is thereby particularly advantageous if these materials of the component are resistant to chemicals.

Furthermore, the recesses of the component advantageously comprise in a vertical direction a chamfer, and/or rounded edges and corners are present at the openings of the recesses.

Likewise advantageously, the distance between the non-semicircular, parallel sides of the recesses has dimensions that are between 1% and 10% smaller than the largest diameter of the truncated conical neck of the at least one piece of laboratory equipment and/or than the maximum diameter of the beaded edge-like enlargement of the neck of the at least one piece of laboratory equipment.

Thus, through the outer diameters of the truncated conical necks of the laboratory equipment can be slid into the recess and securely mounted in the larger semicircular section. A forwards and downwards slipping out of the recess by the laboratory equipment is thus reliably prevented.

The particular advantage of the solution according to the invention is that, by means of the standardized inner dimensions of the truncated conical necks of the laboratory equipment, only a small number of dimensions for the recesses, for the distances between the recesses and for the number of recesses in a component is also necessary, which can also be standardized.

As a result of the secure positioning of the laboratory equipment in the recesses, a tipping-over of the laboratory equipment, in particular of glass flasks such as round-bottom flasks, is no longer possible. Likewise, it is also possible, for example, in fume hoods or racks, to gain significant floor space by arranging pieces of laboratory equipment above one another on one side of the fume hoods or racks, while also having good accessibility to the laboratory equipment. The additional provision of glass equipment, such as beakers, or of cork rings is thus also no longer necessary.

Likewise, by means of the variable holding device of the component of the laboratory equipment holder according to the invention on stands or supports, the adaptation of modified experimental assemblies can take place in a quick and uncomplicated manner.

The invention is explained below in greater detail with the aid of an exemplary embodiment.

Wherein:

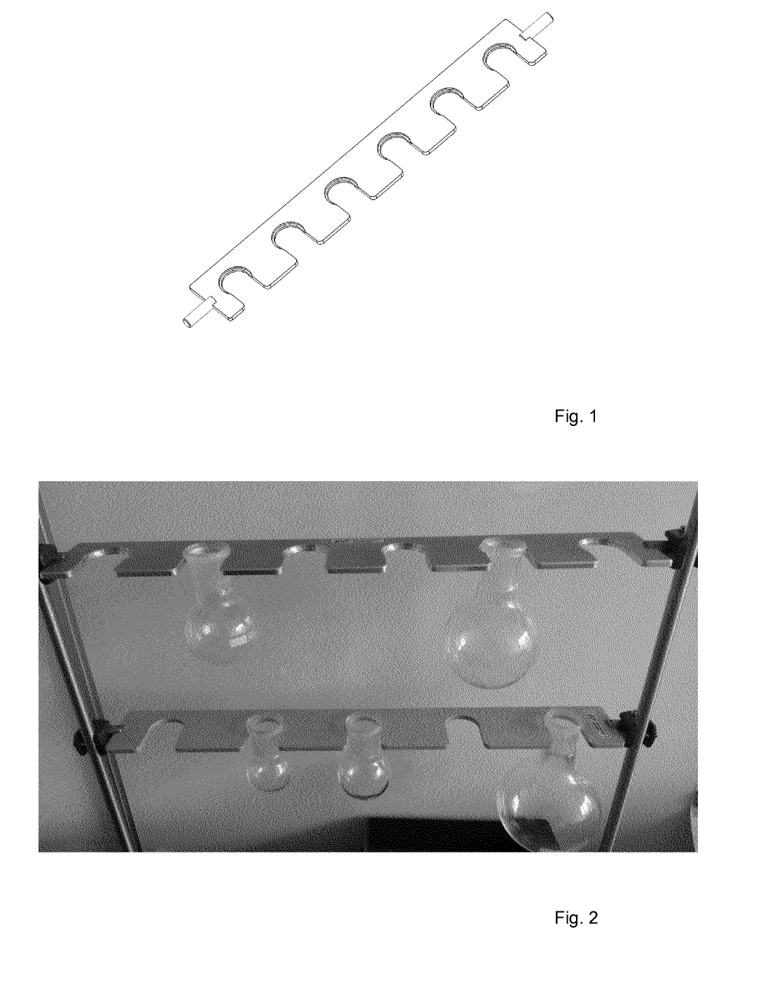

FIG. 1 shows a laboratory equipment holder according to the invention and

FIG. 2 shows a possibility for the arrangement of laboratory equipment holders according to the invention positioned above one another

### EXAMPLE 1

A rectangular component made of stainless steel with the following dimensions: length=480 mm, width=70 mm, height=5 mm comprises on the short sides, each soldered on in the middle, a rod-shaped holding device made of stainless steel on each side, with the following dimensions: length=35 mm, diameter=12 mm. Located at a respective distance of 48 mm from the short sides is in each case the center of the first recess, and respectively located at a distance of 96 mm from this center of the recesses are the centers of three additional recesses. The recesses all have a width of 32 mm, and the smallest diameter of the semicircular sections at the end of each recess has a diameter of 32.48 mm. The corners and edges of the rectangular component are respectively rounded, and the recesses each comprise downwards in a vertical direction a chamfer with a slope of 1/10.

Round-bottom flasks with the following dimensions: diameter=60 mm, total height=105 mm, height of the neck on the round-bottom flask=45 mm, nominal volume=100 mL with an NS 29/32 ground glass joint in the interior of the neck in accordance with DIN can be hung in the five recesses, which flasks are introduced into the recess from the front at the lower section of the truncated conical neck located away from the opening, and are then lowered.

1. A laboratory equipment holder composed of a component and at least one piece of laboratory equipment having at least one neck, which piece of laboratory equipment is arranged such that it is suspended on the laboratory equipment holder, wherein the outer shape of the neck is in the for of a truncated cone with the larger diameter of the truncated cone towards the end of the neck, and/or a beaded edge-like enlargement around the neck is present towards the end of the neck, and wherein at least one holding device is attached to the component, and both the component and also the holding device and the connection between the component and holding device can be mechanically loaded with at least one filled piece of laboratory equipment, and the component comprises on one of its sides at least one recess, and the laboratory equipment is introduced solely from the opening side of the recess, and wherein at least the end of the recess within the component is embodied in an at least semicircular manner, and at least the smallest diameter of the semicircular section of the recess is smaller than the largest diameter of the truncated conical neck of the at least one piece of laboratory equipment and/or is smaller than the largest diameter of the beaded edge-like enlargement of the neck of the at least one piece of laboratory equipment.

2. The laboratory equipment holder according to claim 1 in which the component has a rectangular, round, oval, square, or triangular shape.

3. The laboratory equipment holder according to claim 1 in which the thickness of the component is smaller, in particular significantly smaller, advantageously more than 5 times smaller, than the other dimensions of the component.

4. The laboratory equipment holder according to claim 1 in which the longer sides of the component are longer, advantageously more than 5 times longer, than the short sides, and the thickness of the component is smaller, advantageously more than 5 times smaller, than the length of the short sides.

5. The laboratory equipment holder according to claim 1 in which two holding devices are present on opposite sides of the component.

6. The laboratory equipment holder according to claim 1 in which one or more pieces of glass laboratory equipment, in particular glass flasks such as Erlenmeyer flasks or round-bottom flasks, are positioned in one recess each such that they are suspended simultaneously next to and/or above one another and/or in different sizes and shapes.

7. The laboratory equipment holder according to claim 1 in which the component is composed of metal, such as stainless steel or aluminum, or of plastic or of composite materials, wherein the materials of the component are advantageously resistant to chemicals.

8. The laboratory equipment holder according to claim 1 in which the holding device is present in the form of a rod-shaped holding device, wherein the holding device is connected to the component in a non-positive fit and/or material bond.

9. The laboratory equipment holder according to claim 1 in which at least one, advantageously multiple, such as two to five, recesses are present in the component, wherein the recesses are advantageously arranged at an equal distance to one another and with the same dimensions.

10. The laboratory equipment holder according to claim 1 in which at least two recesses with different dimensions are present in the component and, in the case of more than two recesses, the recesses are present at different distances to one another.

11. The laboratory equipment holder according to claim 1 in which one, multiple, or all recesses comprise in a vertical direction a chamfer and/or comprise rounded edges and corners at the openings of the recesses.

12. The laboratory equipment holder according to claim 1 in which the distance between the non-semicircular, parallel sides of the recesses has dimensions that are between 1% and 10% smaller than the largest diameter of the truncated conical neck of the at least one piece of laboratory equipment and/or than the maximum diameter of the beaded edge-like enlargement of the neck of the at least one piece of laboratory equipment.

13. The laboratory equipment holder according to claim 1 in which the at least semicircular section of the recess constitutes a circular arch segment between ≥180° and <360°, preferably between 190° and 310°, formed by the component material.

14. The laboratory equipment holder according to claim 1 in which the recesses are provided with inserts.
